(19) United States
(12) Patent Application Publication
(10) Pub. No.: US 2025/0231613 A1
(43) Pub. Date: Jul. 17, 2025

(54) VIDEO STREAMING METHOD AND DEVICE OF USER-CONTEXT-INFORMATION-PREDICTION-BASED EXTENDED REALITY DEVICE

(71) Applicant: Korea Electronics Technology Institute, Seongnam-si (KR)

(72) Inventors: Woo Chool PARK, Incheon (KR); Jun Hwan JANG, Goyang-si (KR); Jin Wook YANG, Uijeongbu-si (KR); Min Su CHOI, Seoul (KR); Jun Suk LEE, Seoul (KR); Bon Jae KOO, Suwon-si (KR)

(73) Assignee: Korea Electronics Technology Institute, Seongnam-si (KR)

(21) Appl. No.: 19/098,069

(22) Filed: Apr. 2, 2025

Related U.S. Application Data
(63) Continuation of application No. PCT/KR2023/014842, filed on Sep. 26, 2023.

(30) Foreign Application Priority Data
Oct. 6, 2022 (KR) 10-2022-0127721

(51) Int. Cl. G06F 3/01; G06T 15/04

(52) U.S. Cl. CPC G06F 3/011; G06T 15/04; G06T 2210/56

(57) ABSTRACT

Disclosed herein are a method and apparatus for a video streaming of an extended reality device. According to an embodiment, the method for the video streaming may include a receiving situation information including user location information and pose information at a current point in time from the extended reality device, predicting changes in user location information and pose information at a preset next point in time using pre-learned artificial intelligence receiving, as input, situation information at the current point in time and situation information at a preset previous point in time, rendering an image texture of a video based on the predicted changes in user location information and pose information at the next point in time and transmitting image data with the image texture rendered at the next point in time to the extended reality device, wherein the situation information at the current point in time and the situation information at the present previous point in time configure consecutive frames.

### CROSS REFERENCE TO RELATED APPLICATION

The present application is based on International Patent Application No. PCT/KR2023/014842 filed on Sep. 26, 2023, which claims priority to a Korean patent application No. 10-2022-0127721 filed on Oct. 6, 2022, the entire contents of which are incorporated herein for all purposes by this reference.

### TECHNICAL FIELD

The present disclosure relates to a video streaming method and apparatus of an extended reality device, and more specifically, to a video streaming method and apparatus of an extended reality device capable of saving battery consumption of the extended reality device by predicting situation information at a next point in time using situation information including a user's gaze and movement received from an extended reality device, for example, a virtual reality or augmented reality device.

### BACKGROUND

When providing VR/AR services, users must wear devices, and these devices are uncomfortable to wear. In order to play back images such as realistic 3D objects with low power and high quality, a lot of computing power is required. The demand for a lot of computing resources increases the battery consumption and weight of the device, which increases the discomfort of wearing it on the user's head.

To solve these problems, it is very important to develop technology that utilizes cloud computing resources to handle rendering tasks that require most computing resources, while allowing VR/AR devices to perform minimal tasks.

In other words, the technology to compute prediction of user's situation information, such as gaze and movement, on a cloud server and stream them to a VR/AR device is very important. By doing so, it is possible to reduce VR/AR device battery consumption and achieve lightweight computing resources, and thus it is a very necessary technology.

### SUMMARY

An object of the present disclosure is to provide a video streaming method and apparatus of an extended reality device, which can save battery consumption of the extended reality device by predicting situation information at a next point in time using situation information including a user's gaze and movement received from an extended reality device, for example, a virtual reality or augmented reality device.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a configuration of a video streaming system according to one embodiment of the present disclosure;

FIG. 2 illustrates a configuration of one embodiment of the rendering server illustrated in FIG. 1;

FIG. 3 is an exemplary diagram for explaining changes in user location information and pose information at a next point in time according to a current situation of an extended reality device;

FIG. 4 is an exemplary diagram for VR/AR content;

FIG. 5 is an exemplary diagram for rendered texture image data for a next point in time;

FIG. 6 is a flowchart illustrating an operation of a video streaming method according to another embodiment of the present disclosure; and

FIG. 7 is a configuration diagram of a device to which a video streaming apparatus according to another embodiment of the present disclosure is applied.

### DETAILED DESCRIPTION

Hereinafter, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has another element, this means that one element may further include another element without excluding another component unless specifically started otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

In the present disclosure, since expressions of positional relationships used in this specification, such as top, bottom, left, right, etc., are described for convenience of description, in the case of reverse viewing the drawings shown in this specification, the positional relationship described in the specification may be interpreted in the opposite way.

For purposes of this application and the claims, using the exemplary phrase “at least one of: A, B or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Content reproduction space refers to a space where content is displayed in a coordinated manner, and has different characteristics and limitations according to each XR (VR, AR, VR, MR).

All spaces currently being discussed as metaverse spaces are VR (Virtual Reality) environments, which have worlds with a fixed size, and refer to spaces where all environments are artificially created. When enjoying VR content, users are visually completely disconnected from the real world, and changes in the outside world do not affect the content being played.

In AR (Augmented Reality), a virtual content is played by ‘overlaying’ virtual content created based on objects at the user's point of view and overlapping it with the real world. The location where the content is played changes through simple object recognition, but it is not mixed with the real world.

MR (Mixed Reality) is the same in that virtual object content is played back, but the content is played back in harmony with the real world seen from the user's point of view. When MR content is played, a transparent virtual space with its own coordinate system is first created that represents the real world seen from the user's point of view. Once the virtual space is created, virtual content is placed, and depending on the environment of the real world, the appearance of the content changes and becomes mixed with the real world.

Extended reality (XR) encompasses MR technologies that encompass both VR and AR, and freely chooses individual or combinational utilization of VR/AR technologies to create an extended reality.

The embodiments of the present disclosure are directed to predicting situation information (e.g., changes in the user's gaze or movement) at a next point in time using artificial intelligence based on current situation information received from a user XR device from a rendering server, such as user location information, image information captured by a camera, or pose information, and pre-rendering an image texture of a video at the next point in time based on the predicted situation information, and transmitting image data with the image texture rendered at the next point in time in real time to the user XR device, in order to save battery consumption and achieve lightweight of the user XR device.

At this time, artificial intelligence may predict changes in the user location information and pose information at the next point in time based on the six-degree-of-freedom information for each consecutive frame included in the situation information. In order to learn this artificial intelligence, learning data may be collected, and a learning model may be trained to predict changes in the user location information and pose information at the next period in time based on the collected learning data.

For example, in an embodiment of the present disclosure, the VR/AR content may be point cloud-based content, and a rendering server may utilize a 3D engine to render the point cloud content in real time in a virtual space and transmit it to an XR device so as to play back the point cloud-based content.

That is, embodiments of the present disclosure enable viewing of point cloud-based images requiring high-performance computing resources on widely used terminals or lightweight user devices (or user terminals).

Point cloud-based streaming according to the embodiments of the present disclosure may be utilized in all XR areas because it reproduces content centered on objects.

Briefly, a point cloud refers to data collected by Lidar sensors, RGB-D sensors, etc. These sensors send light/signals to objects and record the return time, calculate distance information of each light/signal, and create a point. A point cloud refers to a set cloud of multiple points spread across a three-dimensional space.

Unlike a 2D image, the point cloud has depth (z-axis) information, so they are basically expressed as an N×3 Numpy array, where each N line maps to one point and has 3 (x, y, z) information.

Hereinafter, a technology that allows point cloud-based content, for example, video content, to be played or enjoyed on lightweight XR devices with little computing power to save battery consumption will be described.

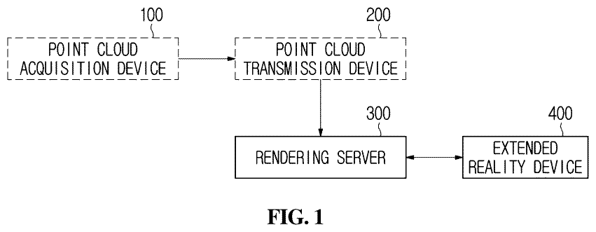

FIG. 1 illustrates a configuration of a video streaming system according to an embodiment of the present disclosure.

Referring to FIG. 1, the video streaming system according to the embodiment of the present disclosure includes a point cloud acquisition device 100, a point cloud transmission device 200, a rendering server 300, and an XR device 400.

When playing back point cloud images to be provided from the rendering server from a local file in the rendering server 300, the point cloud acquisition device 100 and the point cloud transmission device 200 are not required for the system configuration. In this case, the service is possible with only the rendering server 300 and the user terminal 400. Of course, the rendering server 300 may store and use point cloud images that are already compressed due to issues such as capacity.

The point cloud acquisition device 100 refers to a device that collects raw data of point cloud content to be played back in the XR device 400.

At this time, the point cloud acquisition device 100 may acquire a point cloud using a device that acquires a point cloud, for example, Microsoft's Azure Kinect, or may acquire a point cloud from a real object using an RGB camera.

Point clouds may also be obtained from virtual objects via a 3D engine, and ultimately, whether the subject is a real object or a virtual object created with CG, it is output in the form of a point cloud image. However, in the case of real objects, it is common to shoot all sides, so more than one camera is used to shoot. Since the point cloud acquisition device acquires the image in raw format, the output capacity is large.

The point cloud transmission device 200 is a device that transmits point cloud image data acquired by the point cloud acquisition device 100 to the rendering server 300, and transmits compressed point cloud image data to the rendering server 300 via a network device.

At this time, the point cloud transmission device 200 may be a server or a PC.

That is, the point cloud transmission device 200 may receive point cloud image data in the raw format as input and output the compressed point cloud image to the rendering server 300.

Compression of point cloud images requires considerably high-level technology and a high-spec system. Since the compression method and technology of point cloud images are obvious to those skilled in the art, a detailed description thereof will be omitted.

According to an embodiment, the point cloud transmission device 200 may create a single compressed point cloud image after synchronizing data acquired by multiple point cloud acquisition devices when point cloud data is acquired by multiple point cloud acquisition devices 100.

The rendering server 300 is a device corresponding to a video streaming apparatus according to an embodiment of the present disclosure, and renders a compressed point cloud image to reproduce the cloud point image in a virtual space, receives situation information including user location information and pose information at a current point in time from the XR device 400, predicts changes in user location information and pose information at a preset next point in time using pre-learned artificial intelligence that receives as input situation information at a current point in time and context information at a preset previous point in time, renders an image texture of the video based on the changes in the user location information and pose information at the predicted next point in time, and transmits image data with the image texture rendered at the next point in time to the XR device 400.

At this time, the rendering server 300 may receive pose information of the XR device 400 as IMU (Inertial Measurement Unit) information measured by the XR device 400, or may estimate pose information through image analysis when image information captured by a camera is received from the XR device 400. Depending on the situation, the rendering server 300 may also receive internal/external camera parameter values from the XR device 400, and the IMU data values may include acceleration, rotational speed, and magnetometer.

According to an embodiment, the rendering server 300 receives three types of compressed point cloud images (color, geometry, occupancy) as input data and user location information and pose information at a current point in time from the XR device 400, and predicts changes in the user location information and pose information at a next point in time, thereby pre-rendering a two-dimensional image at a next point in time, so that when the user location information and pose information at the next point in time are received, the pre-rendered two-dimensional image may be transmitted to the XR device 400 in real time. Of course, the rendering server 300 may transmit in real time the two-dimensional image at the current point in time, which has already been rendered at a previous point in time, to the XR device 400 when receiving the situation information at the current point in time from the XR device 400.

Here, the rendering server 300 may store the compressed point cloud image in a local file format or may receive the compressed point cloud image from the point cloud transmission device 200.

The rendering server 300 may learn AI in advance, for example, CNN or RNN, to predict changes in user location information and pose information at the next point in time using AI, and may collect learning data for learning AI. For example, the rendering server 300 may collect data on the user's head movement and image information or IMU values on the head movement from multiple mobile devices. At this time, the mobile device may be equipped with software for collecting data, and using the software, the mobile device may collect data on the user's head movement, capture an image with a camera, for example, an ARCore camera, and analyze poses based on the image, record camera pose (6DOF) information for each frame of the image, and save the data in a specific format file. According to an embodiment, the mobile device may save the collected data as a CSV file, and information such as image resolution, Center pixel, Focal length, and 4×4 pose matrix may be stored in the file.

The rendering server 300 may collect natural motion data of the user, that is, learning data, from a mobile device in various situations and environments, and may learn an artificial intelligence to predict changes in the user location information and pose information at a next point in time with respect to input data (e.g., situation information including the user location information and pose information) at a previous point in time and a current point in time using the learning data collected in this manner. According to an embodiment, artificial intelligence may predict changes in the user's location and pose based on 6-degree-of-freedom information for each consecutive frame of a CSV file, and may apply a convolution technique to obtain weight information and pose change prediction information between consecutive image frames. For example, artificial intelligence may be learned by applying a dilated convolution (or atrous convolution) technique to reduce the amount of computation, prevent information loss, and extract only meaningful information, and the artificial intelligence trained in this manner may predict rotation and translation values based on frame-by-frame information through convolution to derive a result.

Of course, the process of learning artificial intelligence in the embodiment of the present disclosure is not limited or restricted to the above-described content, and any learning process for predicting changes in the user location and pose based on the six-degree-of-freedom information for each consecutive frame of the CSV file may be applied.

The XR device 400 measures or acquires location information, pose information, or image information of a user wearing the XR device 400, transmits it to the rendering server 300, and receives and displays image data at the current point in time that has been pre-rendered through prior prediction from the rendering server 300.

At this time, the XR device 400 may measure IMU information of the user terminal using an IMU sensor and transmit the measured IMU information to the rendering server 300, transmit image information captured by a camera and obtain pose information through image-based analysis in the rendering server 300, and obtain pose information in the XR device 400 through analysis of image information captured by the camera and transmit it to the rendering server 300.

The XR device 400 may include any terminal to which the technology according to an embodiment of the present disclosure is applicable, as well as a form of glasses, a headset, or a smart phone, and may have a hardware decoder capable of quickly decoding a 2D image, a display capable of showing an image, a capturing means (e.g., a camera, etc.) capable of capturing an image, an IMU sensor capable of acquiring raw data about the pose of the device, and a network device capable of transmitting IMU information.

Here, the network device may include any network capable of communicating with the rendering server 300, and may include, for example, a device for connecting to a cellular network (LTE, 5G), a device for connecting to Wi-Fi, etc. Of course, the network device may include not only a device with the above function, but also any network device applicable to the present technology.

According to an embodiment, the XR device 400 may obtain the values of the position and rotation matrix of the XR device 400 through the IMU sensor built into the XR device 400. Here, the coordinate system may depend on the system that processes the corresponding data, and for example, in the case of an Android smartphone, it may depend on the coordinate system of OpenGL.

The XR device 400 may configure the position and rotation matrix of the XR device 400 obtained by the IMU sensor into a single 4×4 matrix, and may be expressed as in <Equation 1> below.

$$[ \begin{matrix}{R}_{11} & {R}_{12} & {R}_{13} & {T}_{1} \\ {R}_{21} & {R}_{22} & {R}_{23} & {T}_{2} \\ {R}_{31} & {R}_{32} & {R}_{33} & {T}_{3} \\ 0 & 0 & 0 & 1\end{matrix} ] \qquad [ Equation 1 ]$$

where, R11 to R33 may refer to the rotation matrix of the XR device 400, and T1 to T3 may refer to coordinates indicating the position of the user terminal in the three-dimensional space.

Each matrix element is 4-byte data in float format, and may have a total size of 64 bytes per matrix.

The XR device 400 transmits situation information data to the rendering server 300 according to a transmission method defined in the system. Here, the XR device 400 may transmit situation information data using a raw socket in the TCP method for fast transmission, and may transmit situation information data using the QUIC protocol transmission method in UDP.

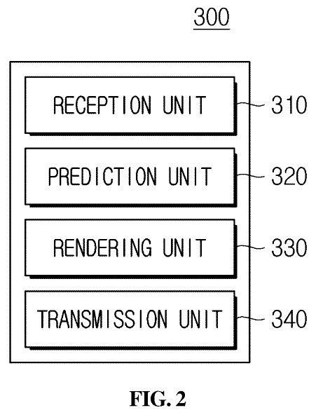

FIG. 2 illustrates a configuration of an embodiment of the rendering server illustrated in FIG. 1, and illustrates a configuration of a video streaming apparatus according to an embodiment of the present disclosure.

Referring to FIG. 2, the rendering server 300 includes a reception unit 310, a prediction unit 320, a rendering unit 330, and a transmission unit 340.

The reception unit 310 receives situation information from the XR device 400, and receives point cloud image data when point cloud image data is transmitted from the point cloud transmission device.

Here, the reception unit 310 may receive user location information and pose information from the XR device 400, and the pose information may include at least one of image information or IMU information (IMU data).

The prediction unit 320 uses pre-learned artificial intelligence that receives, as input, situation information received at the current point in time and situation information received at a preset previous point in time to predict changes in user location information and pose information at a preset next point in time. That is, the prediction unit 320 predicts changes in movement of the user wearing the XR device 400.

At this time, the prediction unit 320 may predict changes in user location information and pose information at the next point in time based on a difference in user location information and pose information between the current point in time and the previous point in time in the artificial intelligence.

According to an embodiment, the prediction unit 320 may acquire pose information at a given point in time by analyzing image information at the given point in time when image information is received through the reception unit 310.

The rendering unit 330 renders an image texture of the video based on changes in the user location information and pose information at the next point in time predicted by the prediction unit 320.

Furthermore, when cloud point data corresponding to a point cloud image is received from the point cloud transmission device, the rendering unit 330 decodes and renders images of each of the channels included in the cloud point data, for example, a color data channel, a geometry data channel, and an occupancy data channel, thereby playing back a cloud point image (VR/AR content) in a space that provides XR services, for example, a virtual space.

The transmission unit 340 transmits image data with the image texture rendered by the rendering unit 330, for example, a 2D image, to the XR device 400 at the next point in time.

The operation of the rendering server including this configuration is explained a little more as follows. The rendering server 300 shall predict how the user location information and pose information have changed at the next point in time by using the situation information transmitted from the XR device 400 and the situation information at the previous point in time in order to pre-render the image at the next point in time. In other words, the rendering server 300 shall predict in advance which part the user is looking at at the next point in time.

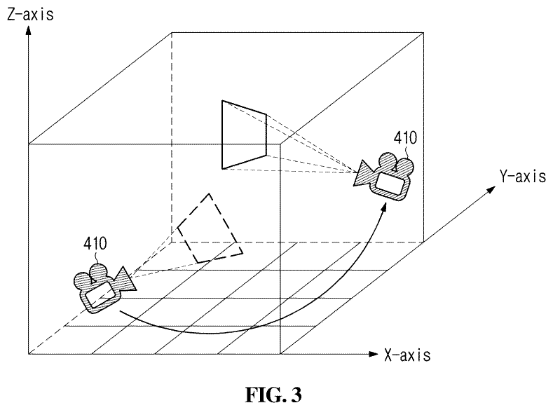

For example, as illustrated in FIG. 3, the rendering server 400 may, assuming that the current point in time is a point in time A, predict the texture image of the image of the next point in time by predicting a point in time B at the next point in time when situation information at the current point in time is received. According to an embodiment, in the case of VR content, assuming that the user's viewpoint is reflected through a virtual camera in the virtual space, the texture image of the image at the point in time B, which is the next point in time, may be rendered in advance by changing a virtual camera 410 already placed at the point in time A to the point in time B.

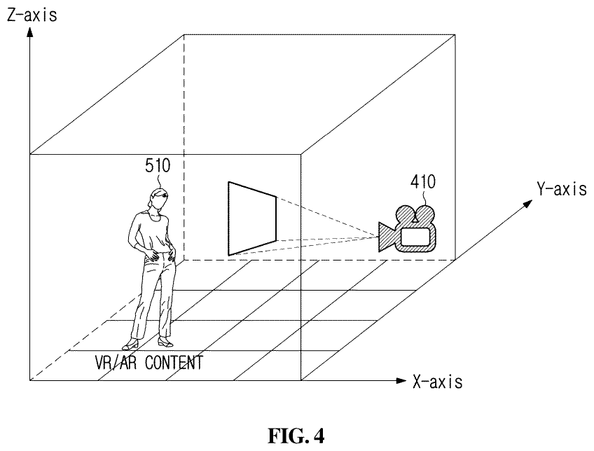

In addition, since the point cloud image is composed of color, geometry, and occupancy for each point, a total of three-channel images shall be played simultaneously. When the rendering server receives three-channel images through the network, each image is received, decoded, and rendered, and the rendered point cloud image is played in a three-dimensional virtual space. For example, as illustrated in FIG. 4, the rendering server 300 may play a point cloud image 510 in a virtual space by receiving a point cloud image and rendering the images of each channel.

The rendering server 300 may instruct the GPU to render the image texture shown by the change in user location information and pose information predicted for the next point in time.

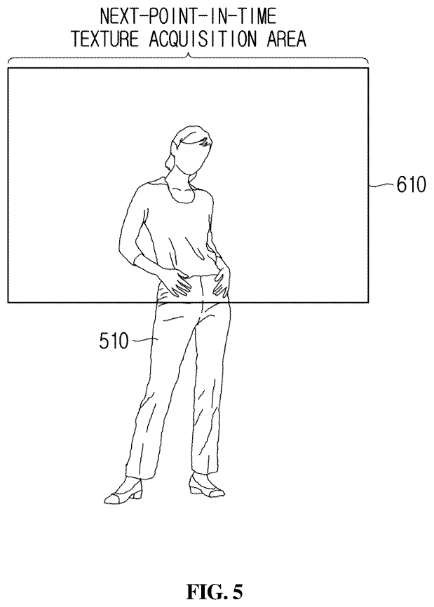

The image texture obtained from the GPU is compressed (or encoded) through a codec such as H.264, HEVC, etc., and the compressed image is muxed again into an appropriate file format to finally generate image data. The 2D image data generated in this manner is transmitted to the XR device 400 at the next point in time through the communication interface, so that the XR device 400 may quickly receive and display the 2D image for the next point in time. For example, the rendering server 300 may generate a 2D image corresponding to a next-point-in-time texture acquisition area 610 as illustrated in FIG. 5 by rendering the image texture of the video 510 corresponding to the next point in time, as illustrated in FIG. 4, and transmits the 2D image of the next-point-in-time texture acquisition area 610 of FIG. 5 generated in this manner to the XR device 400 at the next point in time. This process is repeated in real time.

In this way, in the video streaming apparatus according to the embodiment of the present disclosure, it is possible to view VR/AR content requiring high-performance computing resources on existing widely distributed terminals or lightweight user devices, and to play or enjoy video content on lightweight XR devices with little computing power, thereby saving battery consumption.

In addition, the video streaming apparatus according to the embodiment of the present disclosure can reduce network overload and the resulting computational amount and battery consumption of the XR device, i.e., the user terminal, by predicting changes in the user's movements, etc. of the XR device in the rendering server and pre-rendering the video according to the predicted changes in the user's movements.

In addition, in the video streaming system according to the embodiment of the present disclosure, since complex or variable-rich calculations is performed on the rendering server, the software installed on the XR device can be simplified and compatibility can be increased.

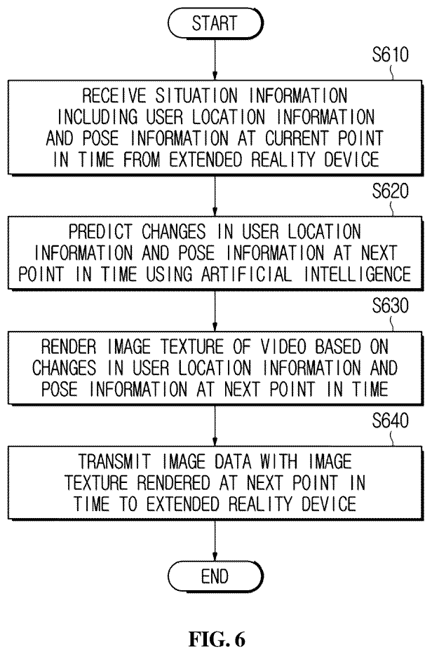

FIG. 6 is a flowchart illustrating an operation of a video streaming method according to another embodiment of the present disclosure, and is a flowchart illustrating an operation performed in the apparatus or system of FIGS. 1 to 5.

Referring to FIG. 6, a video streaming method according to another embodiment of the present disclosure receives situation information including user location information and pose information at a current point in time from an XR device, and predicts changes in user location information and pose information at a preset next point in time using pre-learned artificial intelligence that receives as input situation information at the current point in time and situation information at a preset previous point in time (S610, S620).

Here, in step S620, changes in user location information and pose information at the next point in time may be predicted based on the difference in user location information and pose information between the current point in time and the previous point in time in the artificial intelligence. According to an embodiment, the artificial intelligence may also predict changes in user location information and pose information at the next point in time based on 6-degree-of-freedom information for each consecutive frame included in the situation information.

When changes in user location information and pose information at the next time point are predicted in step S620, image texture of the video is rendered based on the predicted changes in user location information and pose information at the next time point, and image data with the image texture rendered at the next time point, for example, a 2D image, is transmitted to the XR device (S630, S640).

Even though the description is omitted in the method of FIG. 6, the method according to the embodiment of the present disclosure may include all the contents described in the apparatus or system of FIGS. 1 to 5, which is obvious to a person skilled in the art.

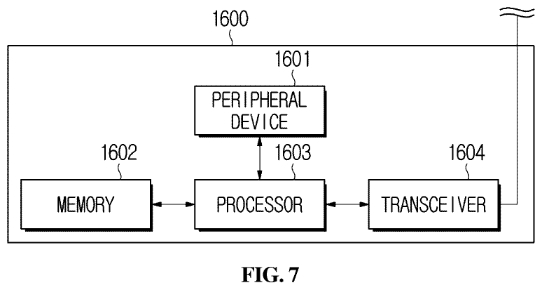

FIG. 7 is a block diagram of a device to which an video streaming apparatus according to another embodiment of the present disclosure is applied.

For example, the video streaming apparatus according to another embodiment of the present disclosure of FIG. 2 may be a device 1600 of FIG. 7. Referring to FIG. 7, the device 1600 may include a memory 1602, a processor 1603, a transceiver 1604, and a peripheral device 1601. In addition, as an example, the device 1600 may further include other configurations and is not limited to the above-described embodiment. At this time, the device 1600 may be, for example, a movable user terminal (for example, a smartphone, a laptop, a wearable device, etc.) or a fixed management device (for example, a server, a PC, etc.).

More specifically, the device 1600 of FIG. 7 may be an exemplary hardware/software architecture such as a content providing server, an extended video service server, a cloud point video providing server, etc. At this time, as an example, the memory 1602 may be a non-removable memory or a removable memory. In addition, as an example, the peripheral device 1601 may include a display, GPS, or other peripheral devices, and is not limited to the above-described embodiment.

In addition, as an example, the device 1600 described above may include a communication circuit such as the transceiver 1604, and may perform communication with an external device based on the same.

In addition, as an example, the processor 1603 may be at least one of a general-purpose processor, a digital signal processor (DSP), a DSP core, a controller, a microcontroller, ASICs (Application Specific Integrated Circuits), FPGAs (Field Programmable Gate Array) circuits, any other type of IC (integrated circuit), and one or more microprocessors associated with a state machine. That is, it may be a hardware/software configuration that performs a control role for controlling the device 1600 described above. In addition, the processor 1603 may modularize and perform the functions of the prediction unit 320 and the rendering unit 330 of FIG. 2 described above.

At this time, the processor 1603 may execute computer-executable instructions stored in the memory 1602 to perform various essential functions of the video streaming apparatus. For example, the processor 1603 may control at least one of signal coding, data processing, power control, input/output processing, and communication operations. In addition, the processor 1603 may control a physical layer, a MAC layer, and an application layer. In addition, as an example, the processor 1603 may perform authentication and security procedures in an access layer and/or an application layer, and is not limited to the above-described embodiment.

For example, the processor 1603 may communicate with other devices through the transceiver 1604. For example, the processor 1603 may control the video streaming apparatus to communicate with other devices through a network by executing computer-executable instructions. That is, the communication performed in the present disclosure may be controlled. For example, the transceiver 1604 may transmit an RF signal through an antenna and transmit a signal based on various communication networks.

In addition, as an example, MIMO technology, beamforming, etc. may be applied as antenna technology, and are not limited to the above-described embodiment. In addition, a signal transmitted and received through the transceiver 1604 may be modulated and demodulated and controlled by the processor 1603, and are not limited to the above-described embodiment.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

According to the present disclosure, it is possible to provide a video streaming method and apparatus of an extended reality device, which can save battery consumption of the extended reality device by predicting situation information at a next point in time using situation information including a user's gaze and movement received from an extended reality device, for example, a virtual reality or augmented reality device.

It will be appreciated by persons skilled in the art that that the effects that can be achieved through the present disclosure are not limited to what has been particularly described hereinabove and other advantages of the present disclosure will be more clearly understood from the detailed description.

According to the present disclosure, a method is provided for a video streaming of an extended reality device. The method may include receiving situation information including user location information and pose information at a current point in time from the extended reality device, predicting changes in user location information and pose information at a preset next point in time using pre-learned artificial intelligence receiving, as input, situation information at the current point in time and situation information at a preset previous point in time, rendering an image texture of a video based on the predicted changes in user location information and pose information at the next point in time and transmitting image data with the image texture rendered at the next point in time to the extended reality device, wherein the situation information at the current point in time and the situation information at the present previous point in time configure consecutive frames.

According to the embodiment of the present disclosure, wherein the receiving comprises receiving inertial measurement unit (IMU) information from the extended reality device as the pose information.

According to the embodiment of the present disclosure, wherein the receiving comprises receiving an image captured by a camera of the extended reality device and acquiring the pose information through analysis of the received image.

According to the embodiment of the present disclosure, wherein the predicting comprises predicting changes in user location information and pose information at the next point in time based on a difference in the user location information and pose information between the current point in time and the previous point in time in the artificial intelligence.

According to the embodiment of the present disclosure, wherein the artificial intelligence predicts changes in user location information and pose information at the current point in time based on 6-degree-of-freedom information for each consecutive frame included in the situation information.

According to the present disclosure, a device is provided for a video streaming apparatus of an extended reality device. The device may include a reception unit configured to receive situation information including user location information and pose information at a current point in time from the extended reality device, a prediction unit configured to predict changes in user location information and pose information at a preset next point in time using pre-learned artificial intelligence receiving, as input, situation information at the current point in time and situation information at a preset previous point in time, a rendering unit configured to render an image texture of a video based on the predicted changes in user location information and pose information at the next point in time; and a transmission unit configured to transmit image data with the image texture rendered at the next point in time to the extended reality device, wherein the situation information at the current point in time and the situation information at the present previous point in time configure consecutive frames.

According to the embodiment of the present disclosure, wherein the reception unit receives an image captured by a camera of the extended reality device and acquires the pose information through analysis of the received image.

According to the embodiment of the present disclosure, wherein the prediction unit predicts changes in user location information and pose information at the next point in time based on a difference in the user location information and pose information between the current point in time and the previous point in time in the artificial intelligence.

According to the embodiment of the present disclosure, wherein the artificial intelligence predicts changes in user location information and pose information at the current point in time based on 6-degree-of-freedom information for each consecutive frame included in the situation information.

According to the present disclosure, a system is provided for a video streaming of an extended reality device. The system may include a rendering server and an extended reality device, wherein the extended reality device acquires situation information including user location information and pose information of the extended reality device at a current point in time to the rendering server, wherein the rendering server, receives situation information at the current point in time from the extended reality device, predicts changes in user location information and pose information at a preset next point in time using pre-learned artificial intelligence receiving, as input, situation information at the current point in time and situation information at a preset previous point in time, rendering an image texture of a video based on the predicted changes in user location information and pose information at the next point in time and transmitting image data with the image texture rendered at the next point in time to the extended reality device, wherein the situation information at the current point in time and the situation information at the present previous point in time configure consecutive frames.

What is claimed is:

1. A video streaming method of an extended reality device, the video streaming method comprising:
receiving situation information including user location information and pose information at a current point in time from the extended reality device;
predicting changes in user location information and pose information at a preset next point in time using pre-learned artificial intelligence receiving, as input, situation information at the current point in time and situation information at a preset previous point in time;
rendering an image texture of a video based on the predicted changes in user location information and pose information at the next point in time; and
transmitting image data with the image texture rendered at the next point in time to the extended reality device,
wherein the situation information at the current point in time and the situation information at the present previous point in time configure consecutive frames.

2. The video streaming method of claim 1, wherein the receiving comprises receiving inertial measurement unit (IMU) information from the extended reality device as the pose information.

3. The video streaming method of claim 1, wherein the receiving comprises receiving an image captured by a camera of the extended reality device and acquiring the pose information through analysis of the received image.

4. The video streaming method of claim 1, wherein the predicting comprises predicting changes in user location information and pose information at the next point in time based on a difference in the user location information and pose information between the current point in time and the previous point in time in the artificial intelligence.

5. The video streaming method of claim 1, wherein the artificial intelligence predicts changes in user location information and pose information at the current point in time based on 6-degree-of-freedom information for each consecutive frame included in the situation information.

6. A video streaming apparatus of an extended reality device, the video streaming apparatus comprising:
a reception unit configured to receive situation information including user location information and pose information at a current point in time from the extended reality device;
a prediction unit configured to predict changes in user location information and pose information at a preset next point in time using pre-learned artificial intelligence receiving, as input, situation information at the current point in time and situation information at a preset previous point in time;
a rendering unit configured to render an image texture of a video based on the predicted changes in user location information and pose information at the next point in time; and
a transmission unit configured to transmit image data with the image texture rendered at the next point in time to the extended reality device,
wherein the situation information at the current point in time and the situation information at the present previous point in time configure consecutive frames.

7. The video streaming apparatus of claim 6, wherein the reception unit receives an image captured by a camera of the extended reality device and acquires the pose information through analysis of the received image.

8. The video streaming apparatus of claim 6, wherein the prediction unit predicts changes in user location information and pose information at the next point in time based on a difference in the user location information and pose information between the current point in time and the previous point in time in the artificial intelligence.

9. The video streaming apparatus of claim 6, wherein the artificial intelligence predicts changes in user location information and pose information at the current point in time based on 6-degree-of-freedom information for each consecutive frame included in the situation information.

10. A video streaming system comprising:
a rendering server, and
an extended reality device,
wherein the extended reality device acquires situation information including user location information and pose information of the extended reality device at a current point in time to the rendering server,
wherein the rendering server:
receives situation information at the current point in time from the extended reality device;
predicts changes in user location information and pose information at a preset next point in time using pre-learned artificial intelligence receiving, as input, situation information at the current point in time and situation information at a preset previous point in time;
rendering an image texture of a video based on the predicted changes in user location information and pose information at the next point in time; and
transmitting image data with the image texture rendered at the next point in time to the extended reality device,
wherein the situation information at the current point in time and the situation information at the present previous point in time configure consecutive frames.
